(19) United States
(12) Patent Application Publication
(10) Pub. No.: US 2010/0243383 A1
(43) Pub. Date: Sep. 30, 2010

(54) CLAMPING DEVICE

(75) Inventors: Benedict KORISCHEM, Dusseldorf (DE); Hans Hölter, Wuppertal (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: PEISELER GMBH & CO. KG, Remscheid (DE)

(21) Appl. No.: 12/728,406

(22) Filed: Mar. 22, 2010

(30) Foreign Application Priority Data
Mar. 24, 2009 (DE) 10 2009 014 117.0

(51) Int. Cl. B23Q 16/08; F16B 2/02; F16D 63/00; B23Q 16/10

(52) U.S. Cl. 188/67; 24/530

(57) ABSTRACT

A clamping device with a housing, a spindle which is rotationally mounted in the housing, and an elastic clamping element, the clamping element being movable by application of a force out of a first position in which the spindle can be turned into a second position in which the spindle is clamped by the clamping element. The clamping element has an inner cylinder which surrounds the spindle to be clamped, an outer cylinder which is located coaxially to the inner cylinder, and a membrane which connects the inner cylinder to the outer cylinder. The clamping element is annular and roughly cup-shaped with an opening in the middle of the clamping element so that the inner cylinder surrounds the spindle to be clamped. The clamping element is shaped and arranged such that, by applying a force to the clamping element the curvature of the membrane can be changed.

### BACKGROUND OF THE INVENTION

1. Field of the Invention

The invention relates to a clamping device with a housing, with a spindle which is pivotally mounted in the housing, and with an elastic clamping element, the clamping element being movable by application of a force out of a first position in which the spindle can be turned, into a second position in which the spindle is clamped by a clamping element. In addition, the invention also relates to an elastic clamping element for use in a clamping device which has a housing and a spindle which is pivotally mounted in the housing.

2. Description of Related Art

Clamping devices are used especially in rotary indexing tables or indexing attachments, with which a clamped workpiece is positioned in a desired angular position in order to be able to then machine the workpiece. The workpiece, depending on the version of the rotary indexing table or indexing attachment, can be arranged horizontally or vertically. So that the given position of a clamped workpiece as it is being machined with a corresponding metal cutting machine, for example, a milling, drilling or grinding machine, does not unintentionally change, a relatively high clamping force must be applied to the spindle by the clamping device.

Clamping can take place either positively, for example, by a rack and tooth system which is coupled in, or frictionally by pressing a brake disk against the pivotally mounted spindle. The configuration of positive positioning of the spindle or a workpiece has the disadvantage that the number of possible indexing steps and thus the number of possible positions are dictated by the number of teeth of the rack and tooth system, so that under certain circumstances a certain position of the workpiece cannot be implemented. For this reason, especially for indexing attachments which are designed to have a high positioning accuracy, preferably frictional clamping of the spindle relative to the stationary housing is accomplished.

German Patent Application DE 103 32 424 B4 discloses a rotary indexing table with a clamping device in which the clamping device has a brake disk which is connected to the spindle, several spring elements which are supported in the housing, and a hydraulically or pneumatically actuatable piston which opposes the spring elements. In the unpressurized state of the piston, clamping of the spindle takes placed by a thin clamping body being pressed by the spring elements against the brake disk. If conversely the piston is supplied with a pressure medium, the piston opposes the spring force of the spring element so that the clamping body is not pressed against the brake disk and the brake disk can thus turn unhindered with the spindle.

German Patent Application DE 103 35 795 A1 and corresponding to U.S. Pat. No. 7,584,828 B2 discloses the initially described clamping device in which frictional clamping of a shaft relative to a stationary housing takes place. This known clamping device has a flat, plate-shaped gripping element as the clamping element which has a bending region which is convex in the initial state, the outer end of the gripping element being supported in the housing and the inner end of the gripping element being able to apply a clamping force to the shaft which is to be clamped. For this purpose, in the known clamping device in the housing a pressure space is formed which on one side is bordered by the convex bending region of the gripping element. If the pressure space is exposed to an overpressure, this leads to a reduction of the curvature of the bending region of the plate-shaped gripping element, by which the free inner end of the gripping element is pressed against the shaft so that the shaft is clamped by the gripping element.

The known clamping device has the disadvantage that the pressure space is functionally open to the inside toward the rotating spindle; this necessitates a more complex seal. So that the curvature of the bending region of the plate-shaped gripping element can be reduced when pressure is applied, it is necessary for the clamping element to have a correspondingly small thickness. But this leads to only a relatively small frictional surface being available for clamping of the spindle, since in the known clamping device the frictional surface is determined by the thickness of the gripping element.

### SUMMARY OF THE INVENTION

Therefore, a primary object of this invention is to provide a new clamping device and a new clamping element for use in a clamping device with which high clamping forces or holding torques can be achieved in a mechanical configuration which is as simple as possible.

This object is achieved in the initially described clamping device in that the clamping element is made roughly cup-shaped and has an inner cylinder which surrounds the spindle to be clamped, an outer cylinder which is located coaxially to the inner cylinder, and a membrane which connects the inner cylinder and the outer cylinder, and that the clamping element is made and arranged such that by applying a force to the clamping element the curvature of the membrane can be changed, the change of the curvature of the membrane causing a change of the distance of the clamping section of the inner cylinder or the clamping section of the outer cylinder or the membrane to the spindle so that by applying a force to the clamping element the spindle is clamped by the clamping element or clamping of the spindle is released.

The clamping device in accordance with the invention differs, first of all, from the clamping device known from German Patent Application DE 103 35 795 A1 and corresponding to U.S. Pat. No. 7,584,828 B2 in that the clamping element is not formed by a flat, plate-shaped gripping element, but by an essentially cup-shaped clamping element which has an inner cylinder, an outer cylinder and a membrane which connects the two cylinders to one another. First of all, this has the advantage that the friction surface for clamping of the pivotally mounted spindle is not the relatively thin face side of the membrane, but the clamping section of the inner cylinder and/or the outer cylinder, which section can be made wider. With corresponding dimensioning of the width of the membrane, i.e., the radial extension of the membrane, intensification of the clamping force acting on the spindle relative to the force acting on the membrane moreover arises according to the lever ratio between the distance of the force application point on the membrane to the inner cylinder or the outer cylinder on the one hand and the distance between the friction surface on the inner surface or on the outer cylinder and the membrane on the other.

For attachment of the clamping element, the inner cylinder and the outer cylinder each have an attachment region on their free end facing away from the membrane. Preferably, the clamping element is tightly connected, especially screwed to the housing at least by way of the attachment region of the outer cylinder. As an alternative, however, it is also possible for the clamping element to be tightly connected to the pivotally mounted spindle by way of the attachment region of the inner cylinder. If the clamping element is tightly connected to the spindle so that the clamping element turns with the spindle, frictional clamping between the clamping section of the outer cylinder and the housing takes place.

The application of a force to the membrane of the clamping element takes place using an activatable power element, and within the framework of the invention, the power element can be both compressed air or hydraulic oil and also a component which can be especially pneumatically or hydraulically actuated.

According to one preferred configuration of the clamping device in accordance with the invention, the force acts on the inside of the membrane facing the attachment region of the inner cylinder and the outer cylinder, i.e., the activatable power element and the clamping element are arranged relative to one another such that the power element acts on the inside of the membrane facing the attachment region of the inner cylinder and of the outer cylinder. If the power element is made such that it is hydraulically or pneumatically actuated, by pressurizing the membrane from the inside, a pressure space can be easily formed which is closed by the clamping element itself toward the pivotally mounted spindle. In this way, the pressure space need not be sealed relative to the rotating spindle, so that simple sealing elements can be used; this simplifies the configuration and arrangement of the clamping device, for example, in an indexing attachment.

As has already been stated, the membrane can be exposed directly to compressed air or hydraulic fluid, when the inside of the membrane is pressurized the pressure space being closed by the clamping element itself to the pivotally mounted spindle.

Preferably, force is transmitted to the membrane of the clamping element by there being a piston which can be pneumatically or hydraulically actuated and which is arranged and formed such that when pressure is applied the piston acts especially on the middle region or the center diameter of the membrane. It is especially preferred if the piston is supplied with compressed air. The use of a pneumatic system instead of a hydraulic system has the advantage that a much lower operating pressure can be used so that the feed lines are essentially less fault-susceptible, and thus, less maintenance-intensive. In the clamping device in accordance with the invention, it has been ascertained that with operating pressures of a few bars, for example, 6 bars, very high clamping forces and holding torques can be ensured.

Fundamentally, there are various possibilities for how the clamping element and especially the membrane can be made. The membrane, viewed from the direction of the power element, can be made flat, convex or concave so that by activating the power element the curvature of the membrane can be changed, specifically enlarged or reduced in size.

According to a first version of the invention, the membrane is inclined or curved to the outside toward the middle from its outer region and from its inner region so that the membrane—viewed from the direction of the power element—is made essentially convex. If a membrane which has been made in this way is exposed to a force in its middle region, this leads to an increase of the curvature of the membrane. The increase in the curvature of the membrane leads to both the clamping section of the inner cylinder and also the corresponding clamping section of the outer cylinder being pulled to the inside. If the clamping element is dimensioned such that in the inactivated state of the power element, i.e., the membrane is not exposed to a force, the inner cylinder frictionally adjoins the spindle and preferably in addition the outer cylinder frictionally adjoins the housing or a brake disk which is permanently connected to the spindle, by activation of the power element, i.e., by applying a force to the membrane, the clamping of the spindle can be released.

According to a second version of the invention, the clamping element is made such that the membrane is inclined or curved to the inside toward the middle from its outer region and from its inner region so that the membrane, viewed from the direction of the power element, is made essentially concave. According to one preferred configuration of this clamping element the angle of incline of the membrane is between 90° and 110°, preferably between 95° and 105°. If a force is applied to a clamping element which is configured in this way on the inside of the membrane, this leads to a reduction of the curvature of the membrane; this results in the distance of the clamping section of the inner cylinder to the spindle. If in this configuration of the membrane the clamping element is dimensioned such that the clamping region of the inner cylinder has an at least small distance to the spindle, the spindle can be turned relative to the clamping element when the power element has not been activated, while the spindle is clamped by the clamping element by activating the power element, i.e., by applying a force to the membrane.

According to one alternative configuration of the second version of the clamping element in which the membrane is inclined to the inside, there is a second power element which applies a force to the membrane and whose direction of force opposes the direction of force of the activated first power element. In this way, a clamping device can be implemented in which with the first power element inactive the spindle is clamped by the clamping element as a result of the force applied by the second power element to the membrane, while clamping is released when the first power element is activated. The second power element can be implemented, for example, by one or more spring elements. If the first power element has a piston which can be pneumatically or hydraulically actuated, in this configuration, clamping of the spindle takes place in the unpressurized state of the piston, while the spindle of the piston must be a pressurized for release of the clamping. Fundamentally, the first and/or the second power element can also be compressed air or hydraulic fluid so that the membrane can be exposed to compressed air or hydraulic fluid from both sides.

It was stated initially that a change of the curvature of the membrane causes a change of the distance of the clamping section of the inner cylinder or of the clamping section of the outer cylinder to the spindle. If the clamping element is tightly connected to the housing and the clamping section of the inner cylinder frictionally adjoins the spindle, radial clamping takes place on the inner cylinder of the clamping element. At this point, the clamping element can be made such that, in this second clamping position of the clamping element, the outer cylinder with a clamping section also adjoins the housing so that radial clamping to the housing additionally takes place on the outer cylinder.

According to one especially preferred configuration of the clamping device in accordance with the invention, the outer cylinder, in the second position of the clamping element which clamps the spindle with one clamping section, does not adjoin the housing, but the corresponding section of a brake disk which is tightly connected to the spindle. It is fundamentally possible here for the clamping element to be dimensioned such that, in the second clamping position, only the outer cylinder adjoins the brake disk. Preferably, the clamping element is, however, made such that both the inner cylinder with its clamping section adjoins the spindle and the outer cylinder with its clamping section adjoins the brake disk so that both on the inner cylinder and also on the outer cylinder of the cup-shaped clamping element radial clamping of the spindle takes place.

According to one alternative configuration of the clamping device in accordance with the invention, the clamping element is made such that in the second position of the clamping element in which the spindle is clamped by the clamping element, the inner cylinder with its clamping section adjoins the spindle and the clamping section of the membrane located in the vicinity of the outer cylinder adjoins the housing. In this configuration of the clamping device, between the clamping section of the inner cylinder and the spindle, radially acting clamping is thus accomplished and between the clamping section of the membrane which is located in the vicinity of the outer cylinder and which is assigned to the outer cylinder, and the housing, axially acting clamping is accomplished. Preferably in this configuration of the clamping element the second, outer clamping section of the membrane does not adjoin the housing, but adjoins the brake disk which is solidly connected to the spindle, here preferably both clamping of the spindle taking place by way of the brake disk and also directly by way of the inner cylinder of the clamping element.

The clamping which is acting axially in this configuration between the clamping section of the membrane and the section of the brake disk can be implemented by the clamping element being made such that the outer cylinder is inclined from its attachment region toward the membrane in the direction to the inner cylinder. A section of the outer cylinder which is inclined to the inside in this way leads to the clamping section of the membrane which is located in the vicinity of the outer cylinder is deformed in the same direction as the force acting on the membrane when the curvature of the membrane is reduced by application of a force. In this way, the clamping section of the membrane comes into contact with the correspondingly arranged region of the brake disk.

As was stated above, the clamping device preferably has a brake disk which is solidly connected, especially screwed, to the spindle, and which in the second position of the clamping element with the clamping section of the outer cylinder or the clamping section of the membrane forms frictional clamping. The brake disk is preferably made and arranged such that the section of the brake disk in the second position of the clamping element with its side facing away from the clamping section of the outer cylinder or the clamping section of the membrane adjoins the housing. In this way the clamping action of the brake disk can be easily intensified.

As was already stated initially, this invention relates not only to a clamping device, but also to an elastic clamping element for use in a clamping device which has a housing and a spindle which is pivotally mounted in the housing. The elastic clamping element in accordance with the invention is characterized in that the roughly cup-shaped clamping element has an inner cylinder which surrounds the spindle which is to be clamped, an outer cylinder which is located coaxially to the inner cylinder, and a membrane which connects the inner cylinder and the outer cylinder. The clamping element is made such that, by applying a force to the clamping element, the curvature of the membrane can be changed, a change of the curvature of the membrane causing a change of the distance of the clamping section of the inner cylinder to the opposite section of the outer cylinder or a clamping section of the membrane located in the vicinity of the outer cylinder, so that in the mounted state of the clamping element, by applying a force to the clamping element, the spindle can be clamped by the clamping element or clamping of the spindle can be released. With respect to the advantages of this elastic clamping element, reference is made to the previous statements in conjunction with the clamping device in accordance with the invention.

The membrane of the clamping element, viewed from the direction of the power element or the attachment regions, can be made flat, convex or concave. Preferably, the membrane is inclined to the inside toward the middle from its outer region and from its inner region, the membrane tilt angle being especially between 90° and 110°, so that the membrane is made roughly concave. In this clamping element, the membrane preferably has a thickness from 0.6 to 2.5 mm. This thickness of the membrane, at a relatively lower operating pressure for a pneumatically actuated piston as the power element, enables a sufficient reduction of the curvature of the membrane so that a correspondingly high clamping force on the spindle or a correspondingly high holding torque can be achieved. At the same time, this thickness of the membrane however also ensures relative stiffness of the clamping element.

The force which is necessary for sufficiently changing the curvature of the membrane or the required operating pressure can be reduced or the allowable thickness of the membrane can be increased by several radially running slots being formed in the membrane. By forming radially running slots the tangential deformability of the membrane is increased, as a result of which the resulting clamping force can be increased.

In particular, there is now a host of possibilities for configuring and developing the clamping device in accordance with the invention and the elastic clamping element in accordance with the invention. For this purpose reference is made to the description of preferred embodiments in conjunction with the accompanying drawings.

### BRIEF DESCRIPTION OF THE DRAWINGS

FIG. 1 is a sectional view of a first embodiment of the clamping device as part of the indexing attachment,

FIG. 2 is an enlarged sectional view of part of the clamping element of the clamping device as shown in FIG. 1,

FIG. 3 is an enlarged sectional view of part of one alternative embodiment of a clamping element,

FIG. 4 is a sectional view of a second embodiment of the clamping device as part of the indexing attachment,

FIG. 5 is a sectional view of the clamping element of the clamping device as shown in FIG. 4,

FIG. 6 is a sectional view of another embodiment of a clamping device, and

FIG. 7 is a perspective of part of the clamping element in accordance with the invention.

### DETAILED DESCRIPTION OF THE INVENTION

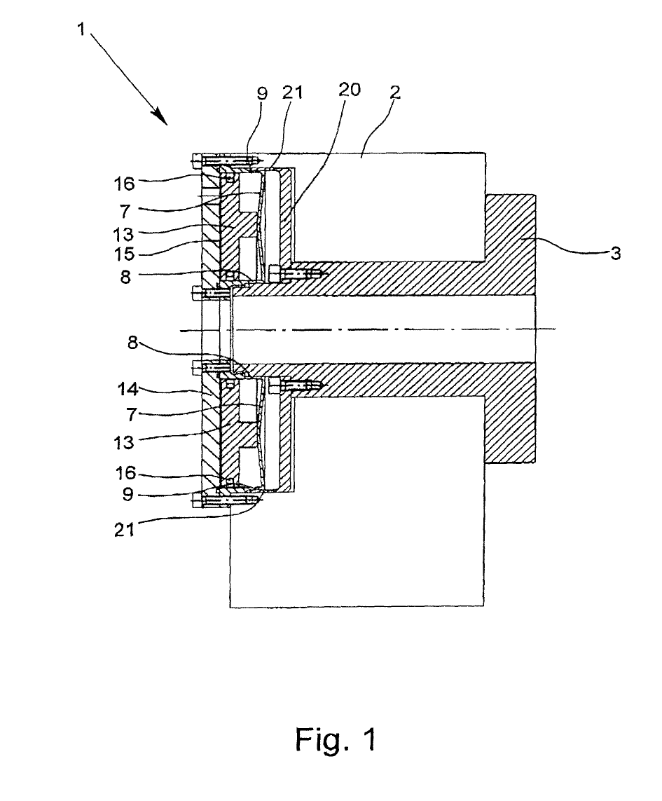

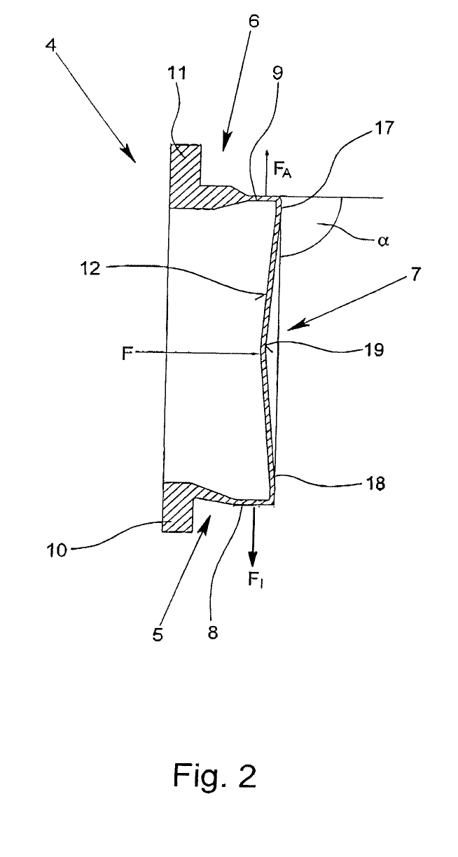

FIG. 1 shows a first exemplary embodiment of a clamping device as part of an indexing attachment 1, the clamping device including a housing 2, a spindle 3 which is pivotally mounted in the housing 2, and an elastic clamping element 4 (see, FIG. 2). The housing 2 which belongs functionally to the clamping device, at the same time, constitutes the housing 2 of the indexing attachment, and the housing 2 itself can also be formed of several housing parts which are connected, especially screwed or welded, to one another.

The indexing attachment 1, which is shown in FIG. 1, is used to position a clamped workpiece in any angular position of the spindle 3 so that the workpiece can then be machined in the desired position by means of the metal-cutting machine, for example, a milling, drilling or grinding machine. For positioning of the workpiece, the indexing attachment 1 has a drive device, such as a worm gear drive as in the illustrated embodiment. A face plate can be attached to one end side of the spindle 3 for attachment of a workpiece which is to be machined.

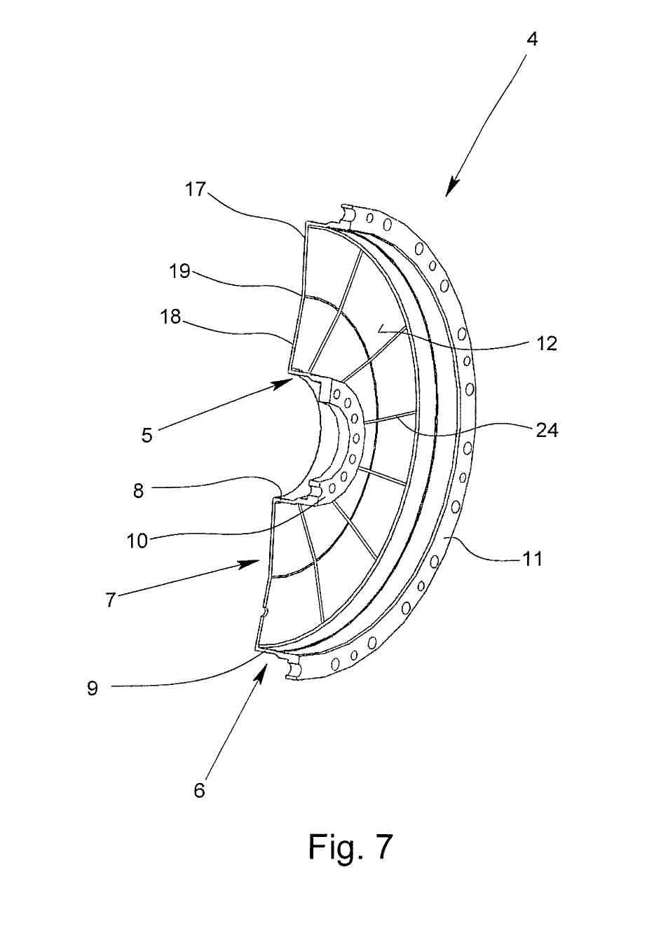

As is apparent from FIGS. 1 & 2, the clamping element 4 in accordance with the invention has an inner cylinder 5 which surrounds the spindle 3 which is to be clamped, an outer cylinder 6 which is located coaxially to the inner cylinder 5, and a membrane 7 which connects the inner cylinder 5 and the outer cylinder 6. The membrane 7 is located essentially perpendicular to the inner cylinder 5 and to the outer cylinder 6. The clamping element 4 which is shown in perspective in FIG. 7 is thus made annular roughly cup-shaped, in the middle of the annular “cup-shaped” clamping element 4, the inner cylinder 5 forming an opening which surrounds the spindle 3 which is to be clamped. The clamping element 4, which preferably is made of a high-strength spring steel, can be produced as a turned part. As an alternative, the inner cylinder 5, the outer cylinder 6 and the membrane 7 can also be produced as three individual parts which are then connected to one another for forming the clamping element 4.

In the clamping device shown in FIG. 1, clamping of the spindle 3 takes place by a force F being applied to the membrane 7 in the direction of the arrow shown in FIG. 2, as a result of which the curvature of the membrane 7 is reduced; in turn, this leads to the clamping section 8 of the inner cylinder 5 being deformed to the inside, in the direction of the spindle 3 or in the direction of the arrow shown in FIG. 2 with F₁. Radially acting clamping thus takes place between the spindle 3 and the clamping section 8 of the inner cylinder 5 when a force F is applied to the membrane 7. Likewise, the outer cylinder 6 has a clamping section 9 which is deformed when a force F is applied to the membrane 7 in the direction of the arrow shown in FIG. 2 with F_{A}.

For the clamping device, between the spindle 3 and the inner cylinder 5 of the clamping element 4 there can be a ring of hardened steel in order to prevent damage to the spindle 3 in the clamping process as a result of the high clamping forces which occur. As an alternative, the spindle 3 can also be hardened accordingly in the region opposite the inner cylinder 5.

Moreover, as can be taken from the figures, the inner cylinder 5 and the outer cylinder 6 of the clamping element 4 each have an attachment region 10, 11 which is made as a flange on their free end facing away from the membrane 7, in the illustrated embodiments, the clamping element 4 being screwed tightly to the housing 2 via the attachment region 11 of the outer cylinder 6.

The arrangement and configuration of the clamping device are furthermore simplified by the force F acting on the inside 12 of the membrane 7 which is facing the attachment region 10, 11 of the inner cylinder 5 and the outer cylinder 6. The force F is applied by a piston 13 which can be hydraulically or preferably pneumatically actuated, the piston 13 acting on the middle region of the membrane 7. As an alternative, then, the membrane 7 can also be directly pressurized by compressed air or hydraulic fluid.

The piston 13 shown in the figures can be both a single piston and also a tandem piston. On the side of the piston 13 facing away from the membrane 7, a cover 14 is connected to the attachment regions 10, 11 of the clamping element 4 so that a pressure space 15 is formed between the cover 14 and the piston 13. Because a force F is applied to the membrane 7 on its inside 12 by way of the piston 13, and due to the pot-shaped configuration of the clamping element 4 the pressure space 15 need not be sealed relative to the turning spindle 3. Thus, single sealing elements 16 can be used for sealing of the pressure space 15.

In the exemplary embodiments of the clamping element 4 which are shown in FIGS. 2 & 5, the membrane 7 is inclined to the inside from its outer region 17 and from its inner region 18 toward the middle 10, so that the membrane 7 is made roughly concave with respect to the piston 13. The angle of inclination α of the membrane 7 is preferably between 90° and 110°, especially between 95° and 105°. In this clamping element, the membrane 7 preferably has a thickness from 0.6 to 2.5 mm. This thickness of the membrane, at a relatively lower operating pressure for a pneumatically actuated piston as the power element, enables a sufficient reduction of the curvature of the membrane so that a correspondingly high clamping force on the spindle or a correspondingly high holding torque can be achieved. However, at the same time, this thickness of the membrane also ensures relative stiffness of the clamping element.

The force which is necessary for sufficiently changing the curvature of the membrane 7 or the required operating pressure can be reduced or the allowable thickness of the membrane 7 can be increased by several radially running slots being formed in the membrane. By forming radially running slots, the tangential deformability of the membrane 7 is increased, and as a result of which the resulting clamping force can be increased.

Fundamentally, the clamping element 4 can be made and located within the housing 2 such that, in the second position in which the spindle 3 is clamped by the clamping element 4, only the inner cylinder 5 with its clamping section 8 adjoins the spindle 3. In the illustrated embodiment as shown in FIGS. 1 & 2, however, the outer cylinder 6 also has a clamping section 9 which is pressed radially to the outside in the direction of the arrow F_{A} in FIG. 2 when a force F is applied to the membrane 7. In the second position of the clamping element 4, then, not only does radially acting clamping take place between the inner cylinder 5 and the spindle 3, but in addition also radially acting clamping between the outer cylinder 6 and a brake disk 20 which is screwed tightly to the spindle 3. The brake disk 20 is made such that it has a section 21 which runs essentially parallel to the outer cylinder 6 and which is frictionally adjoined by the clamping section 9 of the outer cylinder 6 in the second position of the clamping element 4.

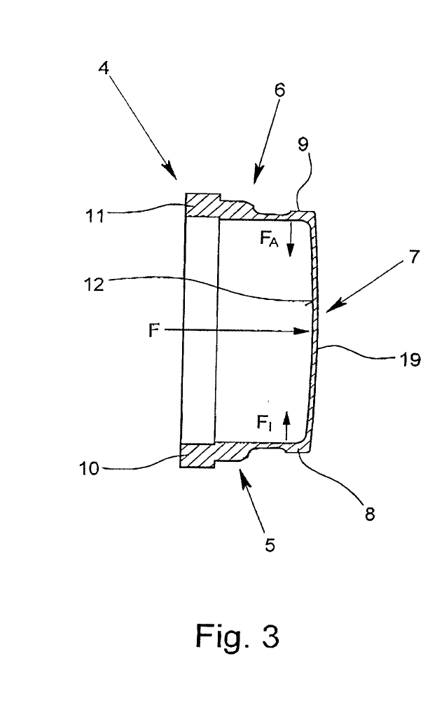

In contrast to the exemplary embodiment of the clamping device or of the clamping element 4 as shown in FIGS. 1 and 2, in the clamping element 4 shown in FIG. 3 the membrane 7 is arched to the outside so that the membrane 7 viewed from the direction of the power element is made essentially convex. If in this configuration the membrane 7 is exposed to a force F, this leads to an increase of the curvature of the membrane 7 which has formed in the unpressurized state. The increase of the curvature of the membrane 7 leads to both the clamping section 8 of the inner cylinder 5 and also the clamping section 9 of the outer cylinder 6 being drawn to the inside.

As is shown in FIG. 3 by the arrows F₁ and F_{A}, when the membrane 7 is exposed to a force F the clamping region 8 of the inner cylinder 5 is raised off the spindle 3. At the same time the clamping section 9 of the outer cylinder 6 is also lifted off the corresponding section 21 of the brake disk 20 so that by applying a force F to the membrane 7 the clamping of the spindle 3 can be released. Thus FIG. 3 shows a configuration of a clamping element 4 or a clamping device in which the spindle 3 is clamped in the unpressurized state, while to release the clamping the membrane 7 must be exposed to a force F. In contrast, in the exemplary embodiment shown in FIGS. 1 and 2 clamping in the unpressurized state is not active, i.e., the piston 13 must be pressurized for clamping of the spindle 3.

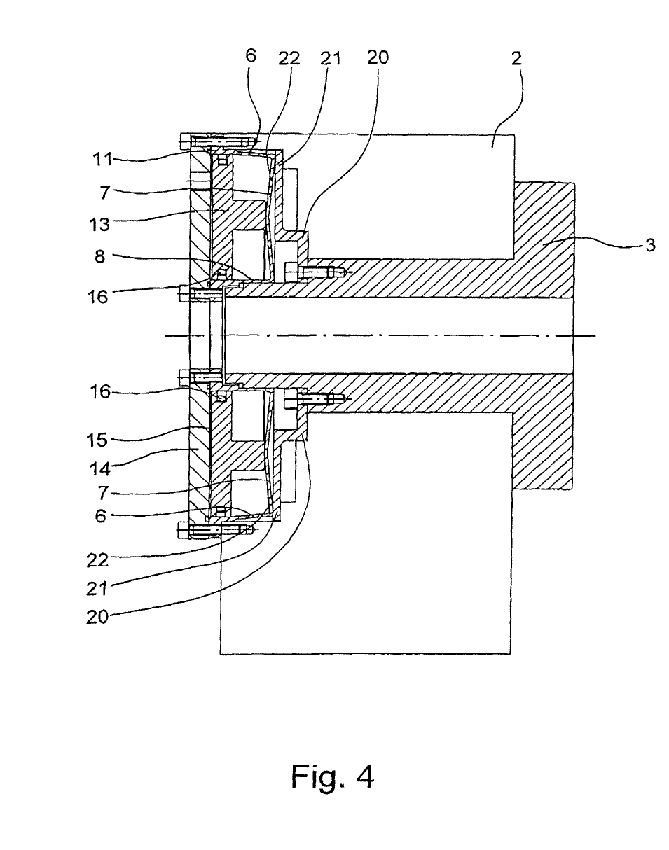

In the illustrated embodiment of the clamping device or the clamping element 4 as shown in FIGS. 4 & 5, the membrane 7, in the same manner as in the embodiment as shown in FIGS. 1 & 2, is inclined to the inside from its outer region 17 and from its inner region 18 toward the middle 19 so that the membrane 7 is made essentially concave relative to the piston 13. Moreover, in this embodiment, the piston 13 acts on the inside 12 of the membrane 7 when pressure is applied.

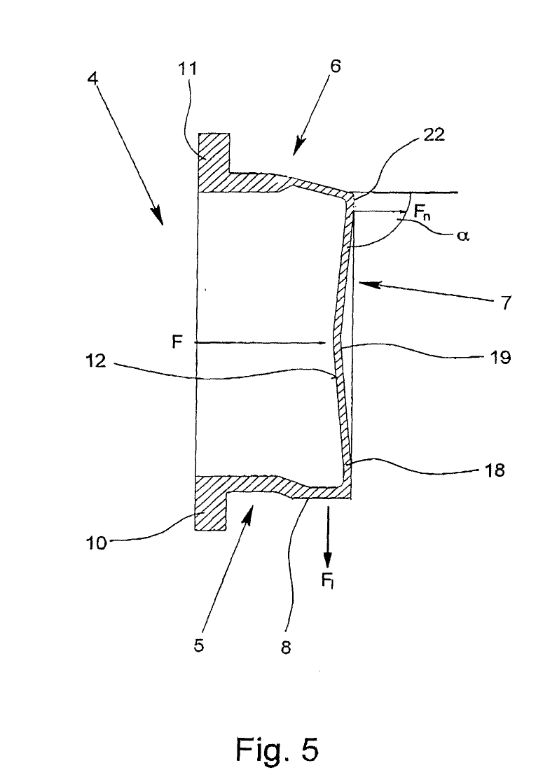

However, the clamping element 4 as shown in FIG. 5 differs from the clamping element 4 shown in FIG. 2 in that, in the embodiment shown in FIG. 5, the outer cylinder 6 is inclined in the direction to the inner cylinder 5 from its attachment region 11 toward the membrane 7. This leads to axial deformation of the clamping section 22 of the membrane 7 located in the vicinity of the outer cylinder 6 in the direction of the arrow F_{M} in FIG. 5 when the membrane 7 is exposed to a force F by the reduction of the curvature of the membrane 7. If a membrane 7 made in this way is exposed to a force F, in addition to the radially acting clamping between the clamping section 8 of the inner cylinder 5 and the spindle 3, axially acting clamping also takes place between the clamping section 22 of the membrane 7 and a corresponding section 21 of the brake disk 20 which is permanently connected to the spindle 3.

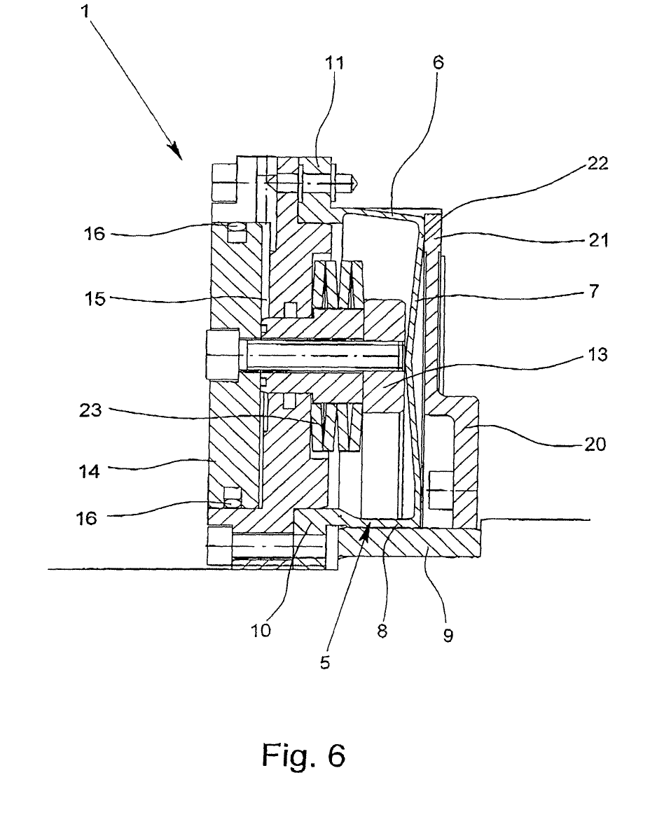

FIG. 6 shows another embodiment of a clamping device, in this clamping device according to the embodiment as shown in FIG. 3 there being clamping of the spindle 3 in the unpressurized state, while for release of the clamping the piston 13 must be pressurized. The clamping element 4 shown in FIG. 6 in terms of its shape corresponds essentially to the clamping element 4 shown in FIG. 5. In contrast to the configuration as shown in FIG. 4, the clamping device shown in FIG. 6 in addition to the piston 13 which can be pressurized as the first power element has an additional spring element 23 in the form of two plate springs as a second power element. The piston 13 is pressed against the membrane 7 by the spring element 23 when the first power element is not activated, i.e., when the pressure space 15 is not exposed to an overpressure. When the pressure space 15 is pressurized the piston 13 is drawn away from the membrane 7 against the spring force of the spring elements 23 so that the membrane 7 springs back into its original shape.

FIG. 6 shows the clamping element 4 in its second position in which both the clamping section 8 of the inner cylinder 5 adjoins the spindle 3 and also the clamping section 22 of the membrane 7 adjoins the section 21 of the brake disk 20. If the pressure space 15 is exposed to an overpressure so that the piston 13 somewhat compresses the spring element 23, this leads to a slight increase of the curvature of the membrane 7; in turn, this leads to both the clamping section 8 of the inner cylinder 5 being raised slightly off the spindle 3 and also the clamping section 9 of the outer cylinder 6 being lifted slightly off the brake disk 20. In this connection, it is pointed out that both the radial deformation of the inner cylinder 5 and optionally of the outer cylinder 6, as well as the axial deformation of the membrane 7, are relatively small, and a small deformation path, for example, of a few hundredths of a millimeter can be sufficient to achieve a correspondingly high clamping force or a high holding torque.

FIG. 7 shows a part of the clamping element 4. In the middle of the annular “cup-shaped” clamping element 4, the inner cylinder 5 forming an opening which surrounds the spindle 3 which is to be clamped. Several radially running slots 24 are formed in the membrane 7 of the clamping element 4, which preferably is made of a high-strength spring steel. As an alternative, there can be arranged several holes in the membrane 7 in order to reduce the force which is necessary for sufficiently changing the curvature of the membrane.

What is claimed is:

1. Clamping device, comprising:
a housing,
a spindle which is pivotally mounted in the housing, and
an elastic clamping element, the clamping element being movable by application of a force from a first position in which the spindle is rotatable into a second position in which the spindle is clamped by the clamping element,
wherein:
the clamping element has an inner cylinder which surrounds the spindle, an outer cylinder which is located coaxially relative to the inner cylinder, and a membrane which connects the inner cylinder to the outer cylinder,
the clamping element is annular roughly cup-shaped, the inner cylinder forming an opening in the middle of the clamping element, and
the clamping element is shaped and arranged such that, by applying a force to the clamping element, the curvature of the membrane is changed, the change of the curvature of the membrane causing a change of the distance of one of a clamping section of the inner cylinder, a clamping section of the outer cylinder and the membrane relative to the spindle.

2. Clamping device in accordance with claim 1, wherein the inner cylinder and the outer cylinder each have an attachment region on a free end thereof which faces away from the membrane.

3. Clamping device in accordance with claim 2, further comprising means for applying a force that acts on an inner side of the membrane that faces toward the attachment region of the inner cylinder and the outer cylinder said force producing a clamping of the spindle.

4. Clamping device in accordance with claim 3, wherein the means for applying a force that acts on an inner side of the membrane is a hydraulically or pneumatically actuated piston that acts on a middle region of the membrane.

5. Clamping device in accordance with claim 1, wherein the membrane is inclined inward toward a middle of the cup shape from the outer and inner cylinders.

6. Clamping device in accordance with claim 1, wherein, in the second position of the clamping element in which the spindle is clamped by the clamping element, both the clamping section of the inner cylinder adjoins the spindle and the clamping section of the outer cylinder adjoins the housing.

7. Clamping device in accordance with claim 1, wherein the spindle is permanently connected to a brake disk and wherein, in the second position of the clamping element in which the spindle is clamped by the clamping element, the clamping section of the outer cylinder adjoins a section of the brake disk.

8. Clamping device in accordance with claim 1, wherein, in the second position of the clamping element in which the spindle is clamped by the clamping element, the clamping section of the inner cylinder adjoins the spindle and a clamping section of the membrane located in the vicinity of the outer cylinder adjoins the housing.

9. Clamping device in accordance with claim 1, wherein the spindle is permanently connected to a brake disk and in the second position of the clamping element in which the spindle is clamped by the clamping element, the clamping section of the inner cylinder adjoins the spindle.

10. Clamping device in accordance with claim 1, wherein the spindle is permanently connected to a brake disk and in the second position of the clamping element in which the spindle is clamped by the clamping element, a clamping section of the membrane located in the vicinity of the outer cylinder adjoins the section of the brake disk.

11. Clamping device in accordance with claim 7, wherein, in the second position of the clamping element, both the clamping section of the inner cylinder adjoins the spindle and also the clamping section of the membrane adjoins the section of the brake disk with its side facing away from the clamping section of the outer cylinder.

12. Clamping device in accordance with claim 1, wherein the spindle is permanently connected to a brake disk and in the second position of the clamping element in which the spindle is clamped by the clamping element, a section of the brake disk adjoins the housing with its side facing away from the clamping section of the membrane.

13. Clamping device in accordance with claim 5, further comprising means for applying a first force that acts on an inner side of the membrane that faces toward the attachment region of the inner cylinder and the outer cylinder and means for applying a second force to the membrane that opposes the first force so that the spindle is clamped by the clamping element when the membrane is not exposed to the first force, while the clamping of the spindle is released when the membrane is exposed to the first force.

14. Clamping device in accordance with claim 1, wherein the membrane has a thickness from 0.6 to 2.5 mm.

15. Clamping device in accordance with claim 1, wherein radially running slots are formed in the membrane.

16. Elastic clamping element for use in a clamping device which has a housing and a spindle which is pivotally mounted in the housing, wherein the clamping element being movable by application of a force from a first position in which the spindle is rotatable into a second position in which the spindle is clamped by the clamping element,
wherein:
the clamping element has an inner cylinder which surrounds the spindle, an outer cylinder which is located coaxially relative to the inner cylinder, and a membrane which connects the inner cylinder to the outer cylinder,
the clamping element is annular roughly cup-shaped,
the inner cylinder and the outer cylinder each have an attachment region on a free end thereof which faces away from the membrane, and
the clamping element is shaped and arranged such that, by applying a force to the clamping element, the curvature of the membrane is changed, the change of the curvature of the membrane causing a change of the distance of a clamping section of the inner cylinder relative to an opposed section of the outer cylinder or a clamping section of the membrane located in the vicinity of the outer cylinder.

17. Elastic clamping element in accordance with claim 16, wherein the membrane is inclined inward toward a middle of the cup shape from the outer and inner cylinders.

18. Elastic clamping element in accordance with claim 16, wherein the outer cylinder is inclined toward the inner cylinder from its attachment region to the membrane.

19. Elastic clamping element in accordance with claim 16, wherein the membrane has a thickness from 0.6 to 2.5 mm.

20. Elastic clamping element in accordance with claim 16, wherein radially running slots are formed in the membrane.
